(19) United States
(12) Patent Application Publication
(10) Pub. No.: US 2012/0242077 A1
(43) Pub. Date: Sep. 27, 2012

(54) Hose Coupling and Protective Hose

(76) Inventors: Neil Shraga, Meyersdal (ZA); Paulo Miguel Pereira Lopes, Johannesburg (ZA); Jan Adriaan Posthumus, Olifansfontein (ZA)

(21) Appl. No.: 13/263,354

(22) PCT Filed: Mar. 31, 2010
(86) PCT No.: PCT/ZA2010/000016

§ 371 Date: Oct. 7, 2011

(30) Foreign Application Priority Data
Apr. 7, 2009 (ZA) 2009/02399

(51) Int. Cl. F16L 35/00; F16L 27/00; F16L 19/00; F16L 55/00; F16L 25/00

(52) U.S. Cl. 285/39; 285/45

(57) ABSTRACT

The invention relates to a hose coupling and a protective hose incorporating such a hose coupling for replacing standard hose couplings and standard hoses, amongst many other applications, on vehicle fue! tanks so as to prevent the theft of fuel from the tanks. The hose coupling comprises of: a fastener body (12); a sleeve (14) surrounding the fastener body (12); retaining means (16) for retaining the sleeve (14) about the fastener body (12) so as to limit the axial movement of the sleeve (14) relative to the fastener (12) while allowing the sleeve (14) to freely rotate about the fastener body (12), even when is use; and a means (18) for capturing a hose stem to which a protective hose is connectable.

### BACKGROUND OF THE INVENTION

THIS invention relates to a hose coupling and a protective hose incorporating such hose coupling. More specifically, the invention relates to a hose coupling and a protective hose combination for preventing the unauthorised removal of the hose coupling and/or protective hose.

Standard hose couplings are well known in the art. However, these standard hose couplings are capable of being tightened or loosened with any normal spanner or wrench. This is particularly problematic where the hose is used in a system where the liquid being transported through the hose is prone to theft, for example diesel in truck fuel tanks.

With the ever increasing price of oil, the problem of diesel theft particularly in the transportation sector of the global economy has worsened. Many security systems aimed at curbing fuel theft are available in the market. These systems include fuel level monitoring and alarm systems, e-tag re-fuelling systems and anti-siphoning systems. Although these systems do, to a certain extent, deter thieves from stealing diesel, one part of most truck fuel tanks remains vulnerable, that is, the hoses extending between tanks or the tank and the trucks engine.

It is an object of the present invention to provide a hose coupling and a protective hose incorporating the hose coupling that is difficult to remove without a specialised tool, thereby, and in one of many possible applications, curbing the theft of fuel.

### SUMMARY OF THE INVENTION

According to the invention there is provided a hose coupling including:
a fastener body;
a sleeve for surrounding the fastener body;
means for retaining the sleeve on the fastener body, the retaining means limiting the axial movement of the sleeve relative to the fastener body while allowing the sleeve to freely rotate about the fastener body; and
a means for capturing a hose on the fastener body.

The hose coupling may further include a hose stem or ferrule being co-operative with the hose capturing means on the fastener body, so as to enable a hose connected to the hose stem or to the ferrule to be captured on the fastener body.

The fastener body may comprise a top end, a bottom end, one or more sides and further, may define a bore extending between the top and bottom ends. Generally, at least a portion of the bore is threaded.

The fastener body may further include one or more first engaging formations for engaging with corresponding one or more second engaging formations on a special tool, which in use, is used to tighten or loosen the hose coupling to a connector body. Typically, the first engaging formations are grooves or keyways defined along the sides of the fastener body and the second engaging formations are corresponding projections or keys protruding radially inwardly from an inner periphery of the special tool. Alternatively, the first engaging formations are projections or keys protruding radially outwardly from the sides of the fastener body and the second engaging formations are corresponding grooves or keyways defined along an inner periphery of the special tool. Reference to a connector body may refer to any body to which the fastener body is threadably engagable.

The fastener body may have any cross-sectional shape. Generally, the cross sectional shape of the fastener body is circular, triangular, quadrangular, hexangular or of any shape having one or more sides. Preferably, the fastener body is a nut.

The sleeve is preferably a tubular body comprising a first open end and a second end having a flange projecting radially inwardly therefrom. Typically, the flange defines an aperture sized and shaped to be captured on a correspondingly sized and shaped flange capturing formation on the fastener body. Generally, the flange capturing formation on the fastener body is a neck protruding axially outwardly from the bottom end of the fastener body. Preferably, the height of the sleeve, between its first and second ends, is substantially similar or greater than the height of the fastener body sides thereby preventing sufficient access to the fastener body for the purposes of loosening or tightening the hose coupling by any tool other than the special tool. More preferably, the height of the sleeve is between 1 and 3 times the height of the fastener body sides. Most preferably, the height of the sleeve is between 1 and 2 times the height of the fastener body sides.

The sleeve may further comprise a preventative formation for co-operating with the connector body to which the hose coupling is attachable so as to prevent the sleeve from exposing the fastener body in an attempt to axially remove the sleeve from the fastener body. Typically, the preventative formation projects axially outwardly from the second end of the sleeve and in use, abutment of the preventative formation with at least a portion of the connector body prevents the sleeve from exposing the fastener body. Preferably, the preventative formation is an extension of the sleeve past the flanged second end of the sleeve. Alternatively, the preventative formation is a tubular member of the same or smaller dimension to the sleeve.

Preferably, the sleeve defines an inner periphery greater than the outer periphery of the fastener body sides, thereby defining a gap between the sleeve and the fastener body sides, the gap being sized and shaped for receiving an engaging end of the special tool.

The retaining means may be located on the neck projecting axially outwardly from the bottom end of the fastener body. Generally, the retaining means is a retaining formation, located proximate the bottom of the neck, co-operative with the flange of the sleeve so as to retain the sleeve on the fastener body. Typically, the retaining formation is a radially outwardly projecting lip running along the outer circumference of the neck. Preferably, the retaining lip of the fastener body is co-operative with a radially inwardly projecting lip running along the inner periphery of the aperture defined by the flange of the sleeve, so as to retain the sleeve on the fastener body. More preferably, the sleeve is press fitted to the fastener body.

The hose capturing means may be a hose capturing formation within or proximate the bore of the fastener body. Preferably, the hose capturing formation projects radially inwardly into the bore at the top end of the fastener body. More preferably, the hose capturing formation defines a hose capturing aperture. The hose capturing formation may be a lip projecting radially inwardly along the upper circumference of the bore.

The hose capturing aperture may be sized and shaped to allow a hose connecting end of the hose stem or the hose to which the ferrule is connected, extending through the bore from the bottom end of the fastener body, to extend through the hose capturing aperture and past the top end of the fastener body. Typically, a sealing end of the hose stem or ferrule, with the hose connecting end or hose to which the ferule is connected extending from the top end of the fastener body, is captive within the bore by abutment between the lip defining the hose capturing aperture and a corresponding primary abutment formation on the hose stem or ferrule respectively. Preferably, the primary abutment formation is proximate the sealing end of the hose stem or ferrule respectively.

The hose stem or ferrule may comprise of a sealing face extending between the sealing end thereof and the primary abutment formation. Generally, the sealing face tapers from the primary abutment formation toward the sealing end of the hose stem or ferrule respectively. Typically, the sealing face defines a first receiving formation to receive a sealing element therein. Preferably, the first receiving formation is a first annular groove extending about the sealing face sized and shaped to receive a correspondingly sized and shaped o-ring therein.

The hose connecting end of the hose stem may comprise of a securing formation for securing the hose connected to the hose connecting end thereon. Generally, the securing formation is notched, barbed or serrated formations located between the hose connecting end of the hose stem and a secondary abutment formation, against which the hose connected to the hose connecting end of the hose stem is abutable. Typically, the hose stem defines a second receiving formation for receiving the flanged end of a crimping collar, which crimping collar crimps the hose to the hose connecting end of the hose stem. Preferably, the second receiving formation is a second annular groove extending about the hose stem. More preferably, the second receiving formation is located nearer the secondary abutment formation than to the primary abutment formation

According to a second aspect of the invention, there is provided a protective hose having at least one hose coupling as described herein connected thereto. Typically, the protective hose comprises of a hose coupling connected to each end thereof. Preferably, the hose coupling includes the hose stem or ferrule. More preferably, the hose coupling and hose stem are crimped to the protective hose. Most preferably, the protective hose is armoured hose so as to make the cutting thereof with ordinary hand tools very difficult and time consuming. Even more preferably, the fastener body of the hose coupling is capable of swivelling relative to the hose stem and connected protective hose. Typically, the protective hose is armoured with steel strands or a steel lattice embedded therein. Alternatively, the protective hose may be any type of piping, for example, plastic-like or metallic piping.

According to a third aspect of the invention, there is provided a special tool for the tightening or loosening of a hose coupling including:
a body; and
second engaging formations on the body for correspondingly engaging with first engaging formations on a fastener body of the hose coupling.

The body of the special tool may be tubular in shape. Typically, the second engaging formations are located within the inner periphery of, and proximate a first engaging end of the tool body. Preferably, the first engaging end of the tool body is sized and shaped to be receivable within a gap defined between the fastener body and a sleeve surrounding the fastener body of the hose coupling.

More preferably, the second engaging formations are grooves or keyways defined along the inner periphery of the special tool, or projections or keys protruding radially inwardly from the inner periphery of the special tool, being correspondingly engagable with the projections or keys, or grooves or keyways of the fastener body respectively.

The tool body may further comprise of tertiary engaging formations on the outer periphery of, and proximate a second end of the tool body, for engaging a wrench, spanner or similar leveraging tool so as to transmit a leveraging force applied to the leveraging tool through the special tool and to the hose coupling thereby enabling the hose coupling to be tighten or loosened.

Preferably, the special tool comprises of two halves for allowing the special tool to be assembled over a protective hose to which the hose coupling is connected. Alternatively, the body of the special tool defines an axial slot, running between the first and second ends of the tool body, sized and shaped to allow the protective hose connected to the hose coupling to pass therethrough. The special tool may be a socket type tool.

According to a fourth aspect of the invention, there is provided a kit including at least one hose coupling as described and illustrated herein and at least one special tool as described and illustrated herein. Typically, the kit further includes a hose stem as described and illustrated herein. Preferably, the kit even further includes a length of protective hose connected to the at least one hose coupling. More preferably, the length of protective hose is a length of armoured type hose. Even more preferably, corresponding engaging formations on the fastener body of the hose coupling and the special tool are variable by shape, number, position and size so as to create a plurality of uniquely profiled hose coupling and special tool combinations.

According to a fifth aspect of the invention, there is provided a database for storage of information relating to the uniquely profiled hose coupling and special tool combinations, wherein the unique profile is recorded against a customer specific serial number, pin number, password, identity number, passport number or any other form of identification, such that on request of the customer for additional hose couplings and/or special tools, the customer's unique profile is determinable by interrogating the database with the customer specific serial number, pin number, password, identity number, passport number or any other form of identification supplied by the customer.

### BRIEF DESCRIPTION OF THE DRAWINGS

The invention will now be described in more detail, by way of example only, with reference to the accompanying drawings in which:

FIG. 1 shows a cross sectional side view of the hose coupling in accordance with the present invention;

FIG. 2 shows an exploded cross-sectional side view of the hose coupling of FIG. 1;

FIG. 3 shows a hidden detailed isometric view of the hose coupling of FIGS. 1 and 2;

FIG. 4 shows a top view of the hose coupling of FIG. 3;

FIG. 5 shows a cross-sectional side view of the hose coupling including a hose stem;

FIG. 6 shows the cross-sectional side view of the hose coupling, including the hose stem, relative to a connector body and a length of protective hose to which the hose coupling is attachable;

FIG. 7 shows a hidden detailed isometric view of a protective hose in accordance with the present invention connected to the connector body, and relative to an unassembled special tool; and

FIG. 8 shows a hidden detailed isometric view of a protective hose of FIG. 7 relative to an assembled special tool.

### DETAILED DESCRIPTION OF THE PREFERRED EMBODIMENT

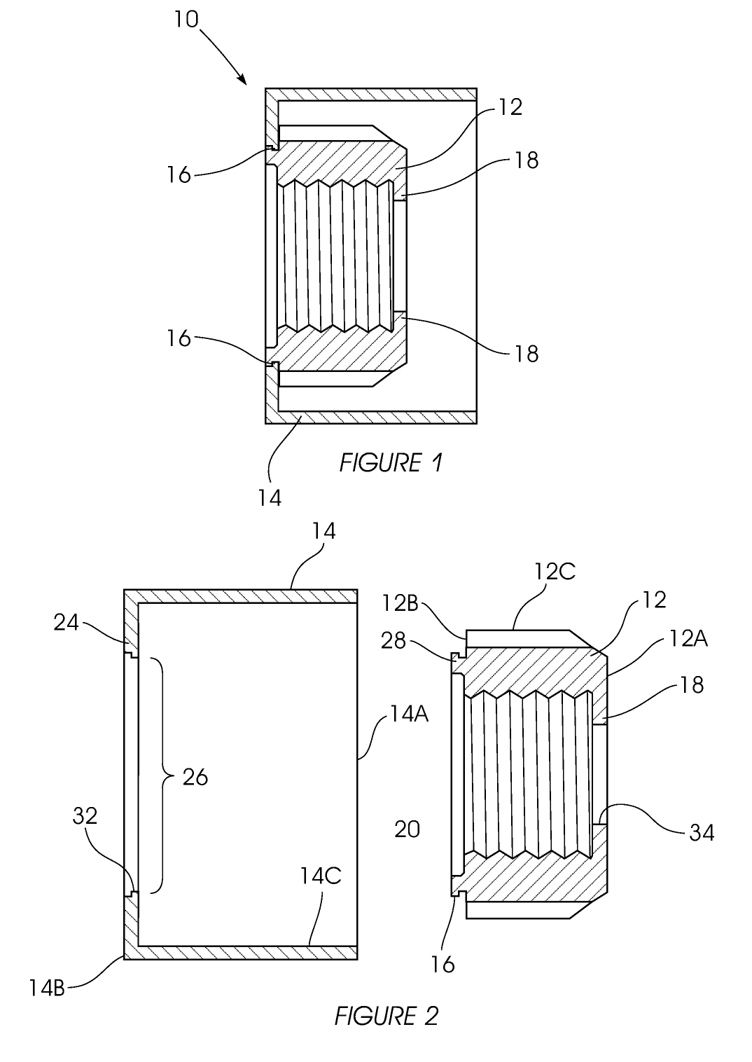

A hose coupling according to a preferred embodiment of the invention is designated generally with reference numeral 10 in FIG. 1. The hose coupling 10 includes a fastener body 12, a sleeve 14, means 16 for retaining the sleeve 14 on the fastener body 12 and means 18 for capturing a hose on the fastener body 12. Although the description to follow will be focused on capturing a hose through a hose stem, it will be appreciated that the hose may be captured on the hose coupling my any other means, for example by a ferrule.

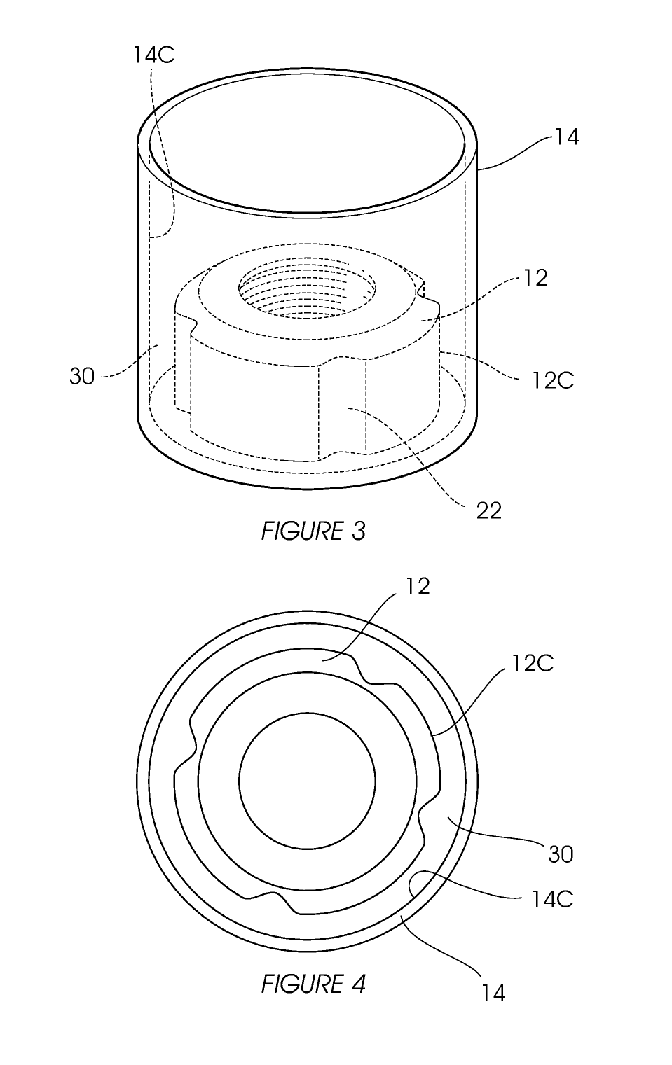

With reference to FIG. 2, the fastener body 12 comprises of a top end 12A, a bottom end 12B, one or more sides 12C and defines a threaded bore 20 extending between the top end 12A and bottom end 12B. As such, the fastener body 12 is in the form of a nut. With specific reference to FIG. 3, the fastener body 12 is depicted with a circular cross-sectional shape defining a plurality of first engaging formations 22 along its sides 12C, which first engaging formations 22 are correspondingly engagable with engaging formations on a special tool, which tool will be described in detail later in the specification.

Although the fastener body 12 is depicted with a circular cross-sectional shape, it will be appreciated that the fastener body may have any cross sectional shape. For example, the fastener body 12 could have a hexagonal cross-sectional shape wherein each of the 6 faces of the hexagonal fastener body 12 define the plurality of first engaging formations 22. Also, the first engaging formations 22 have been depicted as keyways or grooves defined in the fastener body sides 12C. It will further be appreciated that the instead of having keyways or grooves, the first engaging formations 22 may be keys or projections projecting radially outwardly from the fastener body sides 12C.

Referring now back to FIG. 2, the sleeve 14 is a tubular body comprising a first open end 14A and a second end 14B having a flange 24 projecting radially inwardly therefrom. The flange 24 defines an aperture 26 sized and shaped to be captured on a correspondingly sized and shaped flange capturing formation, in the form of a neck 28, protruding axially outwardly from the bottom end 12B of the fastener body 12. The height of sleeve 14 may be of any dimension, so long as it is at least the same or greater than the height of the fastener body sides 12C so as to prevent sufficient access to the fastener body 12 by any tool other than the special tool.

With reference to FIGS. 2 to 4, the sleeve 14 defines an inner periphery 14C being greater than the outer periphery of the fastener body sides 12C so as to define a gap 30 between the sleeve 14 and the fastener body sides 12C, the gap being sized and shaped for receiving an engaging end of the special tool.

The retaining means, in the form of a retaining lip formation 16, projecting radially outwardly from the outer periphery of the neck 28, extends along the entire outer circumference of the neck 28. Co-operation of the retaining lip formation 16 with the flange 24 directly, or with a lip formation 32 projecting radially inwardly from the inner periphery of the flange 24 defined aperture 26, retains the sleeve 14 on the fastener body 12. Generally, the sleeve 14 is assembled onto the fastener body 12 by a press fitting operation.

With specific reference to FIG. 2, the hose capturing means, in the form of a hose capturing formation 18, projects radially inwardly into the threaded bore 20 from the top end 12A of the fastener body 12. The hose capturing formation 18 is a lip, running along the upper circumference of the bore 20 and defines a hose capturing aperture 34.

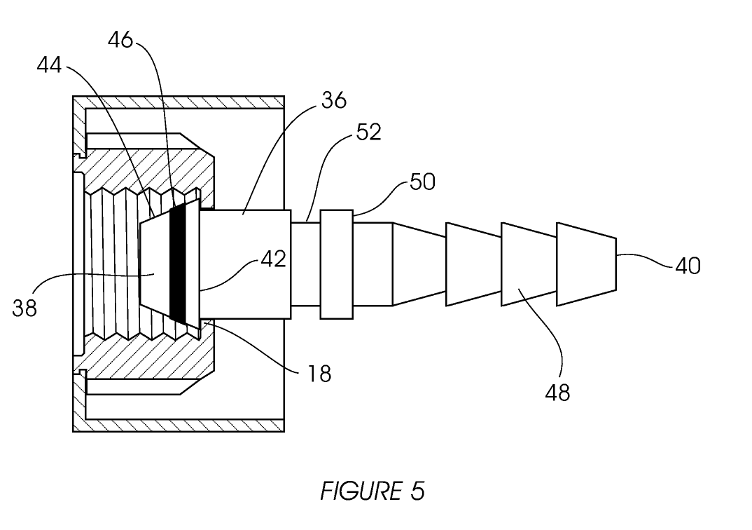

Referring now to FIGS. 2 and 5, the hose coupling 10 further includes a hose stem 36. The hose stem 36 comprises of a sealing end 38 and a hose connecting end 40. The hose connecting end 40 is sized and shaped to pass through the hose capturing aperture 34, while the size and shape of the sealing end 38 of the hose stem 36 prevents the sealing end 38 to pass through the hose capturing aperture 34 due to abutment between the hose capturing lip formation 18 on the fastener body 12 and the primary abutment formation 42 on the hose stem 36. As such, the sealing end 38 of the hose stem 36 is captured within the threaded bore 20 of the fastener body 12.

The sealing end 38 of the hose stem 36 comprises a tapering sealing face 44, which sealing face 44 defines a first receiving formation in which a sealing element, such as an o-ring 46, is receivable. The hose stem 36 further comprises of a plurality of securing formations, in the form of tapered notches 48 for securing a hose connectable thereto securely thereon. The securing formations 48 are located between the hose connecting end 40 and a secondary abutment formation 50, against which a hose connectable to the hose connecting end 40 of the hose stem 36 is abutable. A second receiving formation, in the form of an annular groove 52 extending about the hose stem 36, is located proximate the secondary abutment formation 50. The annular groove 52 is sized and shaped for receiving the flanged end of a crimping collar used to crimp a length of hose to the hose stem 36 of the hose coupling 10, such that in a crimped form, the hose coupling is capable of swivelling relative to the hose stem 36 and/or a hose connected thereto.

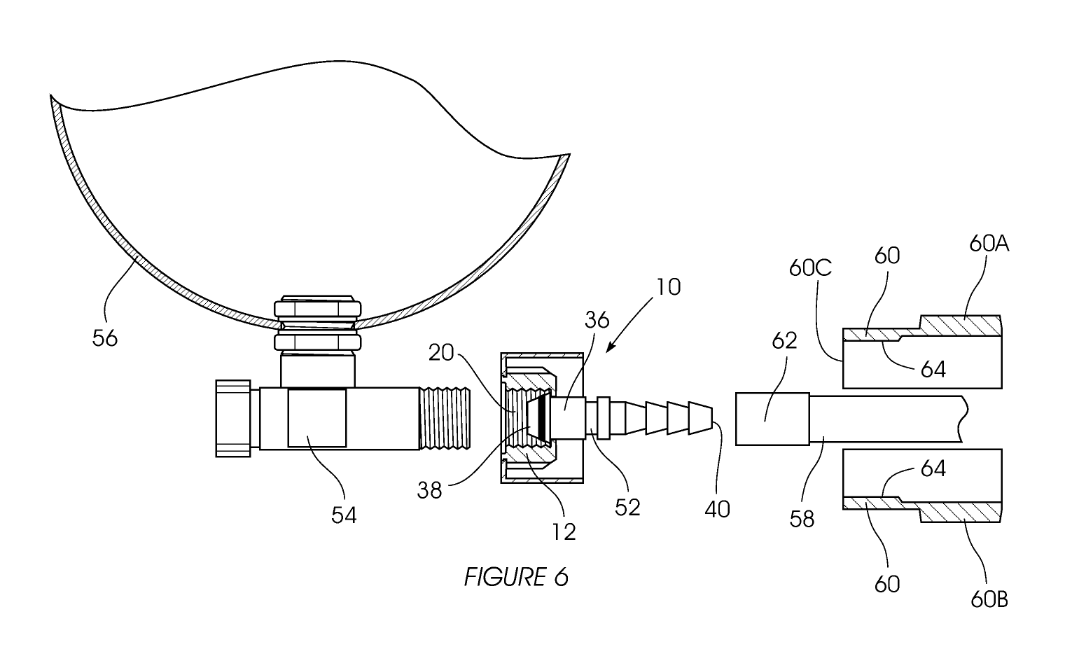

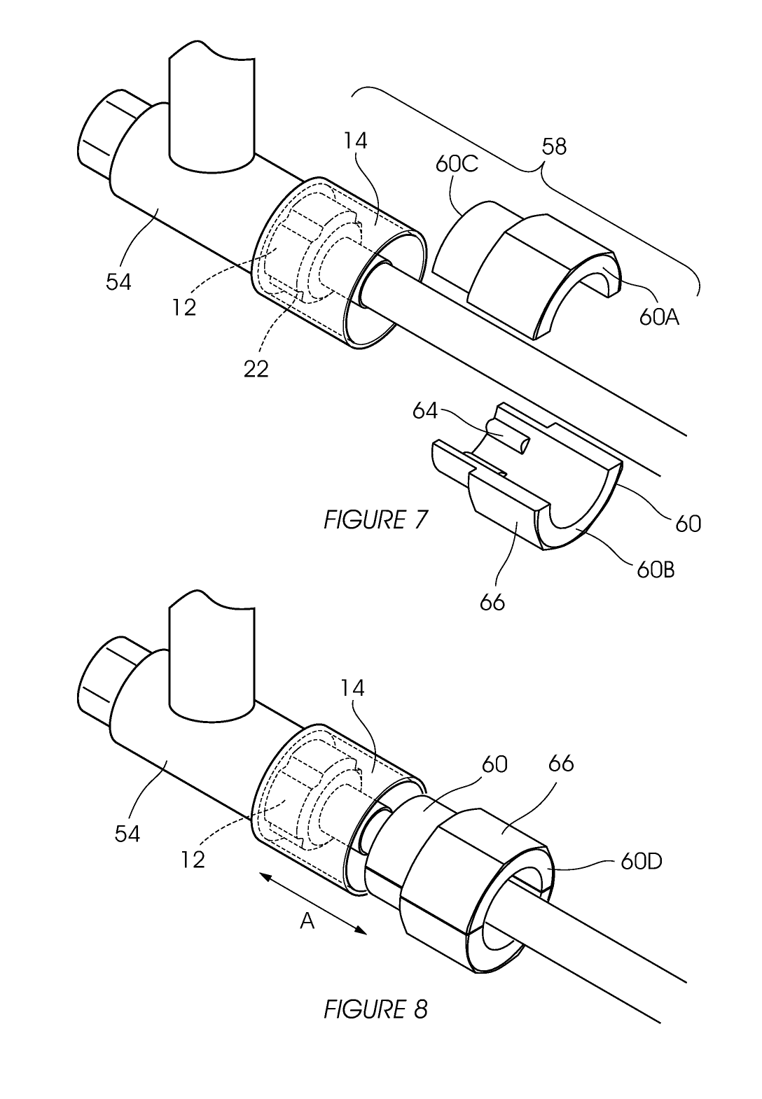

Referring now to FIG. 6, the hose coupling 10 is illustrated relative to a connector body, in the form of a tap 54 attached to the bottom of a tank 56, a length of hose 58 and a special tool 60. The hose stem 36 is positioned within the fastener body 12 such that the hose connecting end 40 extends past the upper end 12A of the fastener body 12, so as to enable the hose 58 to be connected thereto, thereby forming a length of protective hose 58 as illustrated in FIG. 7. The protective hose 58 is preferably a steel armoured hose, making cutting thereof with ordinary hand tools very difficult and time consuming. Generally, the hose 58 is crimped to the hose connecting end 40 of the hose stem 36 with a crimping collar 62 such that the flanged end of the crimping collar 62 is captured within the annular groove 52. In this position, the sealing end 38 is captured within the threaded bore 20 and ready to be tightened to the tap 54 using the special tool 60.

With specific reference to FIGS. 6 to 8, the special tool 60 is tubular in shape comprising of two halves 60A and 60B each having second engaging formations 64 proximate the engaging end 60C of the special tool 60. The second engaging formations 64 are correspondingly engagable with the first engaging formations 22 of the fastener body 12. For the purposes of use, the special tool 60 is assembled over the hose 58 and thereafter guided toward and into the gap 30 defined between the sleeve 14 and the fastener body 12, as illustrated by arrow “A” in FIG. 8. The engaging end 60C of the assembled special tool 60 will only be received within the gap 30 if the first engaging formations 22 and the second engaging formations 64 line up.

Although the second engaging formations 64 have been depicted as keys or projections projecting radially inwardly from the inner periphery of the special tool 60, it will be appreciated that the second engaging formation 64 may be keyways or grooves defined by the inner periphery of the special tool 60. Further, each half 60A and 60B of the special tool 60 comprise of tertiary engaging formations 66 on the outer periphery of the second end 60D of the special tool 60. A wrench, spanner or similar leveraging tool (not shown) can engage the tertiary engaging formations 66 of the special tool 60 so as to transmit a leveraging force, applied to the leveraging tool, through the special tool and to the hose coupling thereby enabling the hose coupling to be tighten or loosened from the connector body 54.

Although the special tool 60 has been depicted in the figures as having two halves 60A and 60B, the special tool 60 could be a single tubular body having a slot defined therein sized and shaped to allow the protective hose 58 to pass therethrough. The special tool 60 is preferably a socket type tool.

The first engaging formations 22 and the second engaging formations 64 on the fastener body 12 and the special tool 60 respectively are variable by shape, number, position and size so as to create a plurality of uniquely profiled hose coupling 10 and special tool 60 combinations.

The information relating to the uniquely profiled hose coupling 10 and special tool 60 combinations is storable in a database and recorded against a customer specific serial number, pin number, password, identity number, passport number or any other form of identification. On request by a customer for a uniquely profiled hose coupling 10 and/or special tool 60, the customer's unique profile is determinable by interrogating the database with the customer specific serial number, pin number, password, identity number, passport number or any other form of identification supplied by the customer.

It will be appreciated that although the invention has been described above with reference to a preferred embodiment, many modifications or variations of the invention are possible without departing from the spirit or scope of the invention. For example, the hose coupling and protective hose can be used in any liquid or gas piping system, as a protective sheath for electrical wires running therethrough or any other type of application.

1-62. (canceled)

63. A hose coupling for a protective hose including:
a fastener body;
a sleeve for surrounding the fastener body;
means for retaining the sleeve on the fastener body, the retaining means limiting the axial movement of the sleeve relative to the fastener body while allowing the sleeve to freely rotate about the fastener body; and
a means for capturing a hose on the fastener body.

64. A hose coupling according to claim 63, wherein the hose coupling further includes a hose stem or a ferrule being co-operative with the hose capturing means on the fastener body, so as to enable a hose connected to the hose stem or to the ferrule to be captured on the fastener body.

65. A hose coupling according to claim 64, wherein the fastener body comprises a top end, a bottom end, one or more sides and further, defines a bore extending between the top and bottom ends where at least a portion of the bore is threaded.

66. A hose coupling according to claim 65, wherein the fastener body includes one or more first engaging formations for engaging with corresponding one or more second engaging formations on a special tool, which in use, is used to tighten or loosen the hose coupling to or from a connector body respectively.

67. A hose coupling according to claim 66, wherein the first engaging formations are grooves or keyways defined along the sides of the fastener body and the second engaging formations are corresponding projections or keys protruding radially inwardly from an inner periphery of the special tool.

68. A hose coupling according to claim 66, wherein the first engaging formations are projections or keys protruding radially outwardly from the sides of the fastener body and the second engaging formations are corresponding grooves or keyways defined along an inner periphery of the special tool.

69. A hose coupling according to claim 67 or claim 68, wherein the fastener body is a nut of any cross-sectional shape and the special tool comprises:
a tubular body formed by two halves capable of being assembled over a protective hose to which one or more hose couplings are connectable; and
second engaging formations on the assembled tubular body for correspondingly engaging with first engaging formations on the fastener body of the hose couplings.

70. A hose coupling according to claim 69 wherein the sleeve is a tubular body comprising a first open end and a second end having a flange projecting radially inwardly therefrom.

71. A hose coupling according to claim 70, wherein the flange defines an aperture sized and shaped to be captured on a correspondingly sized and shaped flange capturing formation on the fastener body.

72. A hose coupling according to claim 71, wherein the flange capturing formation on the fastener body is a neck protruding axially outwardly from the bottom end of the fastener body.

73. A hose coupling according to claim 72, wherein the height of the sleeve, between its first and second ends, is substantially similar or greater than the height of the fastener body sides thereby preventing sufficient access to the fastener body for the purposes of loosening or tightening the hose coupling by any tool other than the special tool.

74. A hose coupling according to claim 73, wherein the sleeve defines an inner periphery greater than the outer periphery of the fastener body sides, thereby defining a gap between the sleeve and the fastener body sides, the gap being sized and shaped for receiving an engaging end of the special tool.

75. A hose coupling according to claim 74, wherein the retaining means are located on the neck and co-operative with the flange of the sleeve so as to retain the sleeve on the fastener body.

76. A hose coupling according to claim 75, wherein the hose capturing means of the fastener body is a hose capturing formation within or proximate the bore of the fastener bod and projecting radially inwardly into the bore at the top end of the fastener body.

77. A hose coupling according to claim 76, wherein the hose capturing formation is a lip projecting radially inwardly along the upper circumference of the bore, the hose capturing formation defining a hose capturing aperture.

78. A hose coupling according to claim 77, wherein the hose capturing aperture is sized and shaped to allow a hose connecting end of the captured hose stem or the hose to which the captured ferrule is connected to extend through the hose capturing aperture and axially past the top end of the fastener body.

79. A hose coupling according to claim 78, wherein a sealing end of the captured hose stem or the end of the hose to which the captured ferrule is connected is captive within the bore by abutment between the lip defining the hose capturing aperture and a corresponding primary abutment formation on the hose stem or ferrule respectively.

80. A hose coupling according to claim 79, wherein the hose stem or ferrule comprises of a sealing face extending between the sealing end thereof and the primary abutment formation, the sealing face tapering from the primary abutment formation toward the sealing end of the hose stem or ferrule respectively.

81. A hose coupling according to claim 80, wherein the sealing face defines a first receiving formation to receive a sealing element therein.

82. A hose coupling according to claim 81, wherein the first receiving formation is a first annular groove extending about the sealing face, the first annular groove being sized and shaped to receive a correspondingly sized and shaped o-ring therein.

83. A hose coupling according to claim 82, wherein the hose couplings are capable of swivelling relative to the hose.

84. A hose coupling according to claim 83, wherein the hose is armoured.
